(19) United States
(12) Patent Application Publication
(10) Pub. No.: US 2024/0256248 A1
(43) Pub. Date: Aug. 1, 2024

(54) Methods and Systems for Providing Data for Consumer Provisioning

(71) Applicant: DIGISEQ LTD., London (GB)

(72) Inventors: Theresa Smith, St. Albans (GB); Colin Tanner, Uxbridge (GB)

(21) Appl. No.: 18/565,552

(22) PCT Filed: Jun. 30, 2022
(86) PCT No.: PCT/EP2022/068184

§ 371 Date: Nov. 30, 2023

Related U.S. Application Data
(60) Provisional application No. 63/217,310, filed on Jul. 1, 2021.

(51) Int. Cl. G06F 8/61

(52) U.S. Cl. CPC G06F 8/61

(57) ABSTRACT

Methods and systems provide for personalizing a wearable (135). The method comprises: providing account data, based on details of a card (140) associated with a token, from a tokenization platform (120) to a personalization server (116); by the personalization server (116), processing the account data into writable data, for transmission to a wearable (135); and, transmitting the writeable data to a device (130) associated with the card (140) and the account data, for personalizing the wearable (135) including writing the writable data to a programmable chip (136), which includes a processing unit, the chip (136) coupled to the wearable (135), from the device (130).

This application is related to and claims priority from commonly owned U.S. Provisional Patent Application Ser. No. 63/217,310, entitled: Methods And Systems For Providing Data For Consumer Provisioning, filed on Jul. 1, 2021, the disclosure of which is incorporated by reference in its entirety herein.

The present disclosure is directed to systems and methods for providing data for consumer provisioning.

Personalization is one of the major cost components and logistical barriers to the mass adoption of “passive” secure smart objects, such as wearables, for example, wearables enabled with an EMV payment account. EMV is a payment method based upon a technical standard for smart payment cards and for payment terminals and automated teller machines which can accept them. EMV originally stood for “Europay®, Mastercard®, and Visa®”, the three companies which created the standard. The need to personalize the wearable with the payment account during fulfillment introduces requirements on the fulfillment process, which are difficult to scale, and significantly reduce the available fulfillment channels.

Personalizing smart card applications, such as payment accounts, from consumer owned computerized devices onto wearables has not always been possible. This is due to factors such as it representing a poor consumer experience in part because the process is difficult to perform for those unfamiliar with undertaking it, and the failure to perform it correctly, resulting in further tasks being required before the process can be completed successfully, and, restrictions introduced by device manufacturers, service providers, or other entities associated with the device, payment account, or service.

Embodiments of the disclosed subject matter allow for service providers, such as card issuers and consumer device manufactures, to add functionality, such as contactless payments, to wearables and other objects, without impacting existing fulfillment channels. As a result, all fulfillment channels used by service providers can be enabled, as the requirement to undertake the personalization process during fulfillment is removed. Additionally, the disclosed subject matter is applicable for use with computerized devices, such as Near Field Communications (NFC), enabled smart phones, using for example, Android® or iOS (Apple®) operating systems (OS). As a result of the disclosed subject matter, service providers, who previously did not find it feasible to undertake personalization during fulfillment, can now add payment functionality to their devices.

Embodiments of the disclosed subject matter provide for the provisioning of data to wearables, for example, as communicated from a device, such as a smart phone (of a user or consumer), to render the wearable suitable for actions, such as payments.

Embodiments of the disclosed subject matter provide for personalization of a wearable in a shorter time than is presently achievable, by contemporary systems.

Embodiments of the disclosed subject matter provide for personalization of wearables using commands which are already existing on the computerized devices, such as smart phones.

Embodiments of the disclosed subject matter include a chip for a wearable, which can be personalized, allowing for the completion of the data transfer for personalization from a computerized device faster than with conventional chips in wearables. The chip includes preprogrammed data, so that the amount of data needed to personalize the chip, and hence, the time to transfer the data from the computerized device is minimized. Additionally, the commands used in personalizing the chip, between the device and the chip are atomic, such that if a failure occurs during the process of data transfer, the process of data transfer can reliably resume from the point of the failure and does not need to start over from the beginning.

Embodiments of the disclosed subject matter include an application downloadable to a computerized device to support personalization of the wearable. The application maps to a computer, such as a server, which provides the data necessary to the computerized device, to personalize the wearable.

Embodiments of the disclosed subject matter provide for the ability to accept personalization data for a conventional personalization, and manipulate it such that it can be used for rapid personalization.

Embodiments of the disclosed subject matter also provide the ability on a Rapid Personalization server to track the progress of personalization on the wearable, and in case of failure, calculate the minimum number of commands required to take the device from its present state to a fully personalized state.

This document references terms that are used consistently or interchangeably herein. These terms, including variations thereof, are as follows.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A ‘wearable’ is an item that a consumer may possess that includes a smart card chip capable of communication with a smart card terminal, for example a payment terminal. It includes devices that may be worn by a consumer such as a ring, wristband, or jewelry, or be in possession of a consumer such as a key fob or card such as jewelry, biometric, display and metal card. Other embodiments may exist in addition to devices worn or in possession of the consumer, such as devices that are attached to or contained within the consumer, or attached to or part of a device used by the consumer.

A “payment application” is, for example, an application conforming to the payment application specifications published by EMVCo (EMVCo is the global technical body that facilitates the worldwide interoperability and acceptance of secure payment transactions by managing and evolving EMV specifications and related testing processes), for example, EMVCo, LLC, A Guide to EMV Chip Technology, Version 2.0, November 2014 (hereinafter EMVCo Version 2.0), including, but not limited to, VSDC (as disclosed in VISA VSDC Contact & Contactless, U.S. Acquirer Implementation Guide, Version 3.0, June 2020) and VMPA (Visa Mobile Payment Application) by Visa, Mchip (M/Chip) Advance and Mchip (M/Chip) Mobile by Mastercard (MChip referenced in EMVCo Version 2.0), DPAS by Discover (referenced in EMVCo Version 2.0), AEIPS (American Express Integrated Circuit Card Payment Specifications which outline American Express (AMEX) EMV implementation requirements and referenced in EMVCo Version 2.0) and Expresspay (Expresspay is the American Express contactless specification, an EMV based payment specification that uses a contactless interface to communicate with a terminal and ensures global interoperability of American Express contactless payment transactions regardless of where they are processed), both from AMEX.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Non-limiting examples of embodiments are described below with reference to figures attached hereto that are listed following this paragraph. Identical structures, elements or parts that appear in more than one figure are generally labeled with a same numeral in all the figures in which they appear, and a numeral labeling an icon representing a given feature in a figure may be used to reference the given feature. Dimensions of components and features shown in the figures are chosen for convenience and clarity of presentation and are not necessarily shown to scale.

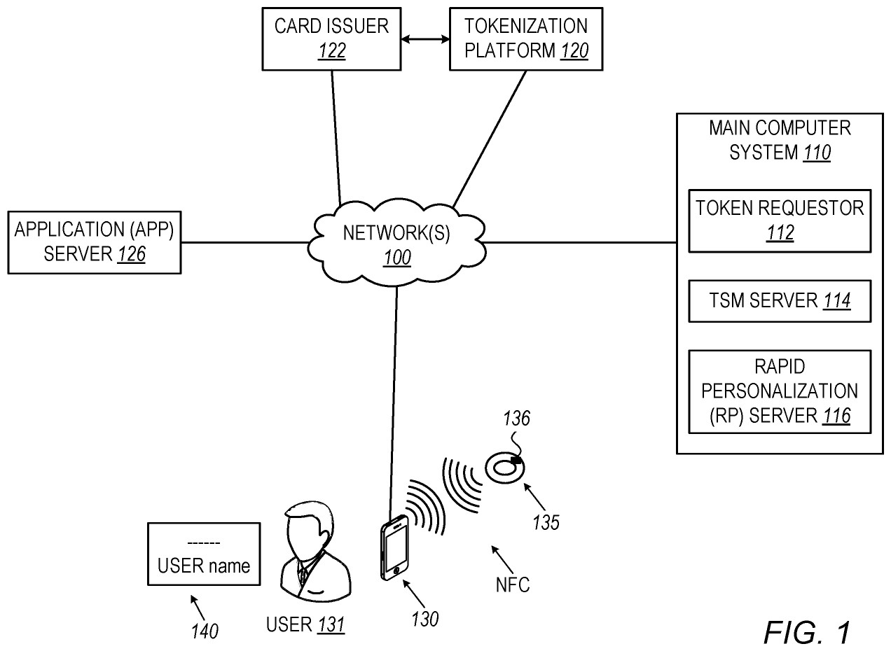

FIG. 1 is a diagram that depicts an example environment in which the disclosed subject matter operates;

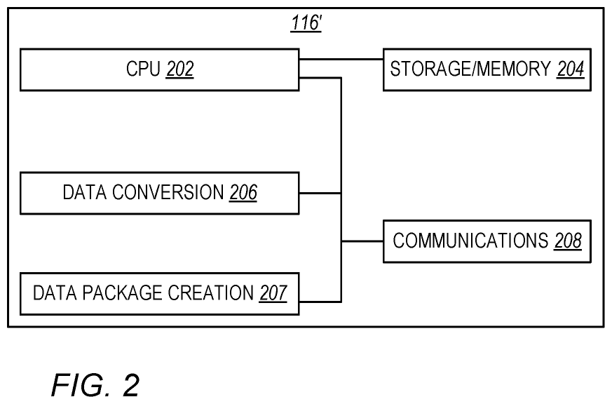

FIG. 2 is a block diagram of a system associated with the Rapid Personalization (RP) server of the main computer system of FIG. 1;

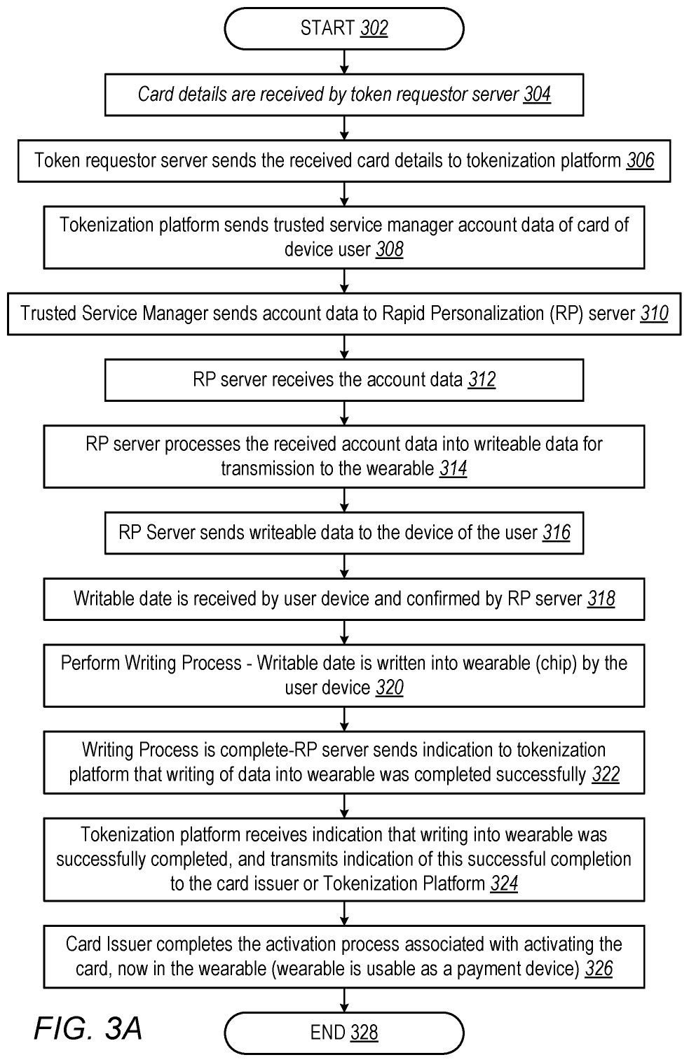

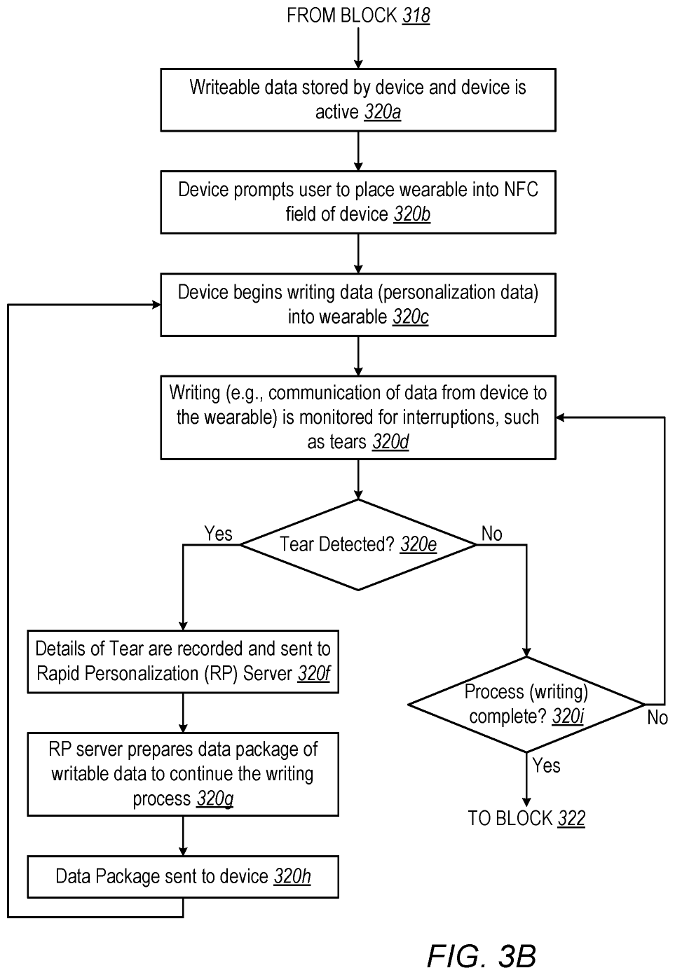

FIG. 3A is a flow diagram showing an example process in accordance with the disclosed subject matter;

FIG. 3B is a flow diagram of an example writing process from a device to a wearable of block 320 of FIG. 3A; and,

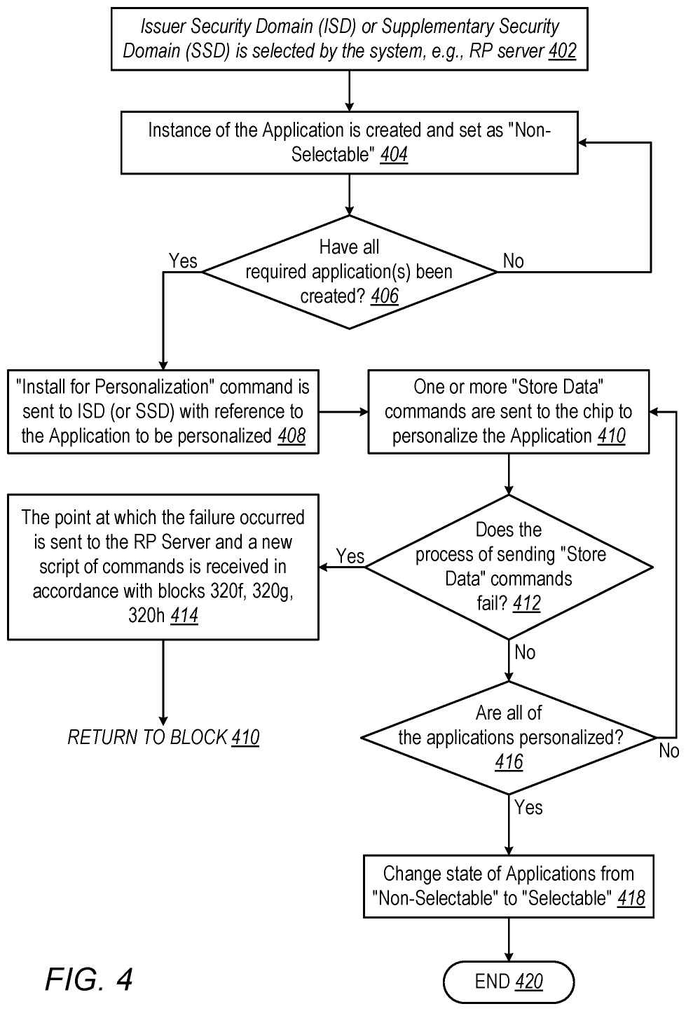

FIG. 4 is a flow diagram of the example writing process from the aspect of a chip of the wearable being personalized.

The present disclosure is directed to methods and systems, which provide for personalizing a wearable. The methods and systems, are operable, for example, to provide account data, based on details of a card, such as a payment card (credit or debit), associated with a token, from a tokenization platform to a personalization server (also known as a rapid personalization server); by the personalization server, processing the account data into writable data, for transmission to a wearable; and, transmitting the writeable data to a device, for example, a smart phone, tablet or lap top computer, or other computing device, associated with the card and the account data, for personalizing the wearable including writing the writable data to a programmable chip, which includes a processing unit (including one or more processors, for example coupled to memory), the chip coupled to the wearable, from the device.

Reference is now made to FIG. 1, which shows an example environment in which personalization of a tokenized account in accordance with the disclosed subject matter is performed. The environment also supports direct personalization of debit, credit, or prepaid accounts.

The environment includes one or more networks 100, which support communications, e.g., electronic and/or data communications, between components 110, 120, 130 in the environment. The networks 100 may include one or more of the Internet, Cellular networks, wide area networks (WAN) (of which the Internet is a public network thereof) and local area networks (LANs), such as an enterprise network.

A main computer system 110 communicates with the network 100. The main computer system 110 includes, one or more computers including servers, such servers including, for example, a token requestor, represented by the server 112 (also referred to herein as a token requestor server), a Trusted Service Manager, represented by server 114, also referred to as a Trusted Service Management (TSM) server, and, a Rapid Personalization (RP) server 116 (also referred to herein as a Personalization server).

The token requestor server 112 functions to collect the cardholders existing card details and packages this data in a format accepted by the tokenization platform 120 such that the cardholder's card can be tokenized.

The TSM server 114 receives personalization data from the tokenization platform and manages the process of forwarding the personalization data to the wearable 135. In this disclosure the TSM server 114 functions to instead send or pass the personalization data to the RP server 116, which then re-formats the personalization data, for forwarding to the wearable 135. For example, the functionality of the RP 116 server may be included directly within the TSM server 114, such that only one physical server may be used. The tokenization platform 120 itself may also be extended to consume the functionality of the main computer system 110 including the functionality of the rapid personalization (RP) Server 116. The Tokenization platform 120 as currently operated by Mastercard (MDES), Visa (VTS) or Thales (TSH) and, for example, is responsible for providing account data sufficient that a token can be personalized to the wearable 135. In the execution of that task, the tokenization platform 120 may interface with the card issuer 122 to ensure only accounts authorized by the card issuer 122 are tokenized. In some embodiments however, it may be the Card Issuer 122, or a party working on their behalf who directly provide the account data to the TSM server 114.

The RP server 116 functions to translate the personalization data received from the tokenization platform 120 or card issuer (server 122) and translates it into a format compatible with the wearable 135, for personalizing a chip 136 (also known as a smart card chip, processor chip or microprocessor chip) coupled to and, for example, within the wearable 135. The RP server 116, for example, functions to track the progress of personalization on the wearable 135, and in case of failure, calculate the minimum number of commands required to take the device from its present state to a fully personalized state. The RP server 116 also monitors the progress of the personalization of the chip 136 within the wearable 135 by the cardholders (user or consumer) 131 near field communication (NFC) enabled device 130, and tracks failures and undertakes creation of new data, should that be required following a failure, for example, an NFC tear.

As used herein in this document, an “NFC tear” occurs, for example, when communication between two NFC devices, such as a smart phone 130 and a wearable 135, is interrupted when one of the devices, e.g., smart phone 130 or wearable 135, has been moved outside the communication range of the other device, causing the chip 136 to lose power. In this document “NFC tear” is also used to describe any communication failure(s) between the user device 130 and the chip 136 within the wearable 135 that cannot be recovered immediately through the NFC transport layer protocol and error recover mechanism.

For example, if a failure occurs, such as an NFC tear, the RP server 116 creates a new package of commands that it sends to the cardholder's 131 NFC enabled device 130. Once the personalization process has been completed it informs the TSM server 114.

The RP server 116 includes a system 116′ of components, detailed in FIG. 2, for performing various portions and operations of the disclosed subject matter. The RP server 116, for example, takes standard personalization data, for example, from the tokenization platform 120/card issuer server 122, via the TSM server 114 and converts it to a standardized format compatible with the chip 135 within the wearable 136 which is sent via the user device 130, for example, a smart (mobile or cellular) phone in communication 130 with the network(s) 100. The RP server 116, for example, also functions to dynamically generate data, should the personalization process of the associated wearable 135 (of the user 131) fail.

The network(s) 100 are used for communication with a tokenization platform, represented by the server 120 (the tokenization platform and server interchangeably referred to by element number 120), which may be the source of the data necessary to allow for personalization of the wearable 135, via the device 130, with data associated with each card 140 (credit/debit/payment) of the user 131. The server 120 communicates with a server 122, representative of a card issuer, e.g., the organization who issues a credit/debit/prepaid payment card. The card issuer 122 may also be the source of the data necessary to allow for personalization of the wearable 135 without the functionality of the tokenization platform 120, but using another party or functionality within the TSM server 114 to perform data generation.

An application (APP) server 126, in communication with the network(s) 100, for example, maintains and stores downloadable (for example, by the device 130) applications for communicating with the wearable 135 (by the smart phone 130) using near filed communication (NFC), and communicating with the RP server 116 during the NFC data transfer process (e.g., personalization process), from the smart phone 130 to the wearable 135, and obtain new personalization data, should the data transfer process fail, for example, from a NFC tear in the data transfer. For example, the application server 126 may host an application service or aggregator, such as Google® Play® Store. The Manage-Mii® application discussed herein is, for example, available from the application server 126, for example, from Google® Play®. A device 130, such as a smart phone, associated with a user 131, representative of devices and their associated users communicates with the networks(s) 100, and each device 130 associated with a wearable 135 (also associated with the user 131). The wearable 135 is, for example, an article including a programmable chip 136, or other data retrievable device, and may be, for example, in the form of a watch, ring, shirt, keychain, wallet, and ‘exotic’ cards, such as jewelry, biometric, display and metal cards, or the like. The chip 136 is programmable from the device 130 by wireless communications, such as Near Field Communication (NFC), and the chip 136 is, for example, compatible with the RP server 116. The chip 136, typically part of the wearable 135, for example, coupled, attached and/or connected thereto, in communication therewith, or incorporated thereon or therein, or otherwise associated with the wearable 135. The chip 136, includes and/or supports, for example, a processing unit (also known as a “data processing unit”) including, for example, one or more processors coupled to memory, network devices, for communicating with computers such as the device 130, and user interfaces (e.g., signal and/or data transceivers), and is programmable, and as such, is programmed to perform various operations. The processing unit of the chip 136 has suitable processing and storage capabilities to perform the operations disclosed herein, including performing the operations of receiving writeable data (by the processor), for example, in the form of commands and/or instructions, for example, associated with applications, programs and the like, for “personalizing” the chip 136 of the wearable 135, and allowing the wearable 135, for example, to operate as a payment device, like a payment card, as the processing unit causes the transmission of payment data and or payment signals, in response to receiving data or signals from a payment requesting computer or computerized device, well as performing other functions.

The chip 136, including the aforementioned components of the processing unit, is designed, for example, to support the “Install for personalization” command for all applications on the device 130 that are used in the personalization process for the wearable 135, as detailed herein, allowing the chip 136 to be programmed (also known as “personalization”). The “Install For Personalization” command is defined by GlobalPlatform Technology Card Specification, Version 2.3.1 Public Release March 2018 Document Reference: GPC SPE 034, from GlobalPlatform, Inc, this document incorporated by reference in its entirety herein, and hereinafter referred to as “GlobalPlatform Specification”, but typically not implemented in many chips, as direct personalization is normally used where the application being personalized is directly selected, and the personalization data is sent or passed directly to it. This “Install for Personalization” command is required to personalize a payment application where the user's smart phone (or device) 130 blocks the direct selection of the application to be personalized, such as is typically on an Apple® iPhone® smartphone, iPAD® tablet computer.

Applications on the chip 136, e.g., programmed onto the chip 136, need to support selectable and un-selectable states as defined by the GlobalPlatform Specification. For example, when an application instance is present on the chip 136, but has not yet been fully personalized, the application on the chip 136 is, for example, set to an un-selectable state, such that any off-chip terminal cannot directly communicate with it. When an application is fully personalized, the final process is to change the state of the application on the chip 136 from non-selectable (cannot be selected by a terminal) to selectable (the application can be selected by a terminal).

Functionality for data sharing in multi-application cards is used in many smart card applications. An example of functionality for data sharing in multi-application cards, may be that disclosed in MasterCard's M/Chip Personalization Data Specifications For Contact and Contactless, See, Mastercard AN 2254-Updated M/Chip Requirements Manual (Dec. 3, 2018). When the functionality for data sharing in multi-application cards, is used, the data personalized into one application may be shared with another application. The first application may be used purely as a ‘vehicle’ to store common data used by multiple applications such that when a new application instance is created, it can adopt (or otherwise utilize) the data stored by the other application. This will in many instances reduce the amount of data that needs to be written to the new application instance, as only data not present in the first application, or that is different to that held by the first application need be personalized.

When personalizing the chip 136 (for example, including the processing unit as detailed above), the commands used in personalizing the chip 136 from the device 130 are atomic. “Atomic” commands are commands that when sent to the chip 136, for example, from the device 130, the command fully completes its intended function, or no change to the persistent state of the device is undertaken. For example, should the command be interrupted by an NFC tear, the chip 136 reverts to a state as if the command was never received and/or started. Example functionality (as defined by GlobalPlatform Specification) which shall support atomic operation for the chip 136 include: Install Application Instance, Delete Application Instance, Store Data, Change state of application instance (selectable/non-selectable), and, Authenticate to device (this typically is a series of commands, which are detailed below).

Security counters are, for example, programmed into the chip 136. The security counters are, for example, used to protect the chip 136, from a brute force attack, where the attacker attempts multiple times to break into a device. Also, the security counters are, for example, set such that multiple NFC tears shall cause the chip 136 to enter a protected state. In a controlled environment, communication errors, such as NFC tears, for example, are not common. Accordingly, the security counters may, for example, be set very low (e.g., three attempts). However, in an uncontrolled environment such as a consumer undertaking the personalization process, such NFC tears should be anticipated, so a higher threshold should be set before invoking security measures. Typically, brute force attacks involve hundreds or thousands of attempts, so increasing the threshold to 20 or 30 attempts typically has no meaningful impact on the security of the device 130.

The chip 136 is, for example, programmed to allow the personalization data written to the chip 130 using the “store data” command to be pre-configured. When an instance of an application is created, this pre-configured personalization data is, for example, present in the newly created instance.

The chip 136, for example, is programmed to accept “store data” commands to be sent multiple times, even for the same data groups (DGI's), up to the point when the personalization is finalized (completed). When a new “store data” command is received for a DGI that has already been personalized, the new data received typically replaces the old (previously stored) data.

Additionally, the chip 136, for example, supports authentication methods in accordance with GlobalPlatform Specification, such as SCP02 or SCP03.

As explained in greater detail below, the writing or personalization process of the chip 136 (transfer of personalization data to the chip 136 from the device 130), and its associated wearable 135, is such that the device 130 monitors the commands being sent to the chip 136. If a failure is detected by the mobile phone 130, the failure is reported to the RP server 116. The RP server 116 then generates a new command script to send to the device 130, which the device 130 then sends to the chip 136 to recover from the failure and continue the writing (e.g., personalization data transfer) to a successful completion. The new script takes into account all commands previously sent to the chip 136, which were successful, such that only commands not previously processed need to be sent from the device 130 to the chip 136.

For example, assuming a script of initially 50 commands, if a failure occurs on the 26th command, the replacement script need only contain the remaining 25 commands (restarting at the 26^{th} command). In this way after each failure, the number of commands should reduce, and the remaining time required will reduce.

Additionally, by including personalization data in the application used to personalize the chip 136, when the instance is first created, for example, when much of the personalization data normally sent to the chip is well known in advance, the number of personalization commands can be reduced. This helps to speed up the personalization process and therefore yield a better consumer experience. If any data that has been pre-personalized is found not to match what is required, it can however be in whole or in part overwritten on the chip 136.

In alternative embodiments, rapid personalization may be supported by pre-personalizing the smart object, i.e., the wearable 135. Where a wearable 135 is intended to be personalized by a known Issuers account, for example with a prepaid account, it is possible that the majority of the account data for that account can be pre-personalized with the exception of the Payment Account Number (PAN) and data directly linked with it. This allows the majority of data to be pre-personalized facilitating a very rapid final personalizing by the consumer. This can be beneficial to the issuer, especially a prepaid issuer, if a large number of wearables are being issued, but the number of wearables that will ultimately be used to perform payment functionality is anticipated to be low. This process will save the Issuer incurring any payment scheme and payment processor fees for issuance of accounts that ultimately are never activated.

Alternately, when the wearable 135 (e.g., chip 136) has been prepersonalized, for example, the device 130 or other computer can be programmed to communicate with the wearable 135 (e.g., chip) so as to read one or more references (also known as indicators) indicating the prepersonalized data on the chip 136, for example, the amount of data, the type of data, on (previously written onto) the chip 136. From this reading of the reference(s), for example, the RP server 116 can determine the amount and/or type or extent of the remaining portion of the account data, needed to be provided as the writable data to the wearable 135, from the device 130, to complete the personalization of the wearable 135. This data to be written into the wearable 135, e.g., chip 136 (incorporated with the wearable 135), includes, for example, the amount of account data, of various data types, corresponding to the remaining account data which was not part of the determined amount of the writable data (e.g., from reading the one or more references) in the portion of the data having at least partially personalized the wearable 135, from the wearable 135.

Alternately, for the chip 136, rather than creating application instances, such as a Payment application and Paypass Payment System Environment (PPSE) application, one by one, the chip 136 may be configured or otherwise preprogrammed to have those instances present in the chip 136 by default. In such an embodiment, a mechanism may be provided by the chip manufacturer to reset the chip back to this default state if required.

FIG. 2 is a block diagram showing the architecture of a system 116′, for example, of the RP server 116. The system 116′ is such that one or more of the components, modules, engines, and the like of the system 116′ may be external to the RP server 116, including, for example, in the cloud. As used herein, a “module”, for example, includes a component for storing instructions (e.g., machine readable instructions) for performing one or more processes, and including or associated with processors, e.g., the CPU 202, for executing the instructions. As used herein, an “engine” performs one or more functions, and may include software programs for performing the processes detailed herein and shown in FIGS. 3A and 3B. Other components are also permissible in the computer system 110, and all components in the system 116′ are linked to and in communication with each other, as well as other components linked to the system 116′ via the network(s) 100, either directly or indirectly.

The Central Processing Unit (CPU) 202 is formed of one or more processors, including microprocessors, for performing functions and operations detailed herein. The processors are, for example, conventional processors, and hardware processors, such as those used in servers, computers, and other computerized devices. For example, the processors may include x86 Processors from AMD (Advanced Micro Devices) and Intel, or other processors by companies such as ARM, as well as any combinations thereof.

The storage/memory 204 stores machine executable instructions for execution by the CPU 202. The storage/memory 204 also includes storage media for temporary storage of data. The storage/memory 204 also includes machine executable instructions associated with the operation of the modules 206, 207, and the communications interface 208.

The data conversion module 206 operates, for example, to process, or otherwise convert, received account data (as received from the trusted service manager 114) into writeable data, as written into the chip 136 of a wearable 135 by a device 130, for personalizing the wearable 135.

The data package creation module 207 functions, for example, to prepare a package of writable data to continue the writing process when the transmission of data of the process is interrupted, for example, by a tear.

The communications module or interface sends and receives data from the RP server 116 to the other components 112, 114 of the computer system 110 and over the network(s) 100, as detailed herein.

FIGS. 3A and 3B are flow diagrams detailing computer-implemented processes and sub-processes in accordance with embodiments of the disclosed subject matter. These processes, for example, are performed by a computer system, such as the main computer system 110 of FIG. 1, including the server system 116′ of FIG. 2. The aforementioned processes and sub-processes are, for example, performed automatically and in real time.

The process begins at block 302, a START block. At the START block 302, the user 131 obtains the requisite wearable 135, including a programmable chip 136 (for example, including the processing unit as detailed above) compatible with the RP server 116. The user 131 (via his device 130) also downloads an application (for example, from the Application (APP) Server 126, which supports personalization with data received from the RP server 116, as detailed at block 314 below. The application is for communicating (electronic and/or data communications) with the wearable (for example, via NFC) and with the RP server 116, to transfer data for programming the chip 136, e.g., personalizing the chip 136 with the user's card data, and communicating process with the RP server 116, for example, to update the status of the data transfer (e.g., writing) process via NFC, and obtain new or continued personalization data from the RP server 116, should the communication/transfer process fail.

The application maps to the RP server 116. The application may be, for example, the Manage-Mii™ application from DIGISEQ of London, UK. The Manage-Mii™ application is a mobile application that allows a smart phone or other user device to add a service to the wearable, track the service's activity, allow for user changes of bank details paired with a wearable, add or delete displayable payment and payment card features, and the like. For example, the Manage-Mii™ application facilitates provision of information, for example, bank card details, from a device onto a wearable. The user adds the wearable 135 to the application. Additionally, the user selects the service that they want to provision onto the wearable 135, for example, a prepaid or tokenized account.

The user 131 enters, via his device 130, his card 140 details, for example, of the card 140 being a credit, debit or other type of payment card, and sends these details to the computer system 110, for example, the token requesting server 112. The user may also have his card 140 details stored or otherwise supplied to the application such that they may not need to directly enter the details themselves. The process now moves to block 304, where the aforementioned card details are received by the token requesting server 112 of the computer system 110.

The process moves to block 306, where the token requestor server 112 sends (transmits) the received card details to the tokenization platform 120. In response, the tokenization platform 120 provides a confirmation (e.g., via a data transmission) to the token requestor server 112.

Moving to block 308, the tokenization platform 120 sends the trusted service manager server 114, of the computer system 110, the account data, which the device 130 will personalize on the wearable 135. The trusted service manager server 114, then sends (transmits or otherwise passes) the aforementioned account data to the RP server 116, at block 310. The RP server 116 receives the account data, at block 312, and processes this received account data into writable data of a format for writing this data into the wearable 135 (via the device 130), at block 314.

The process moves to block 316, where the RP server 116 sends (transmits or otherwise passes) the aforementioned writeable data to the device 130 (via the network(s) 100). The process then moves to block 318, where the writable data is received by the device 130, as confirmed by the RP server 116.

At block 320, a writing process is performed, as the writable data, necessary to personalize the wearable 135, to render it usable, for example, as a EMV compliant Payment device, access control device, Identity device, or loyalty device, is written into (transmitted or sent to) the wearable 135. The writing (transmission or sending) of data by the device 130 to the wearable 135 is, for example, by a near filed communication (NFC) or other type of electronic and/or data communication(s). The actual process of the writing data between the device 130 and the wearable 135 is described in detail below and shown in the flow diagram of FIG. 3B.

With the writing process successfully completed, the process moves to block 322, where the RP server 116 sends an indication to the tokenization platform 120 (via the TSM server 114 that the writing process, e.g., writing of data from the device to the wearable 135, to personalize the wearable 135, was completed successfully.

The process moves to block 324, where the tokenization platform 120 receives the indication, communication, or the like, that the transmission to the wearable was successfully completed, and transmits data for the aforementioned successful completion to the card issuer server 122. At block 326, the card issuer server 122 completes the activation process associated with the card 140 and the wearable 135, and once completed, the wearable 135 is usable, for example, as a payment device. The process moves to block 328, where it ends.

FIG. 3B is a flow diagram of the data writing operation from the device 130 to the wearable 135, of block 320, which is provided in detail. The process begins at block 320a, where the writable data is received by the device 130, from the RP server 116, as detailed above, and stored in the device 130. The device 130 is active, and, for example, running the Manage-Mii™ application.

The process moves to block 320b, where the device 130 prompts the user 131 to place the wearable 135 (with its chip 136) into the range of NFC with respect to the device 130. Moving to block 320c, with the wearable 135 in the field of the NFC, the device 130 begins writing the data into the wearable 135, e.g., the chip 136 thereof.

The process moves to block 320d, where the communication, e.g., the NFC, is monitored for breaks or interruptions, which terminate the data transmission, for example, “NFC tears”. If there is a tear detected, at block 320e, the process moves to block 320f.

At block 320f, the device 130 sends details of the tear to the RP server 116, the details including, for example, the point of the data transfer to the wearable 135, where the tear occurred, the amount of data transferred to the wearable 135, prior to, or up to, the time of the tear, and the like. The process moves to block 320g, where the RP server 116, for example, module 207, prepares a data package for personalization of the wearable 135, for example, a new package from the start of the personalization process, or a package from the point of the tear, or just prior to the point of the tear. The RP server 116 then sends this personalization data package to the device 130, at block 320h, and the process returns to block 320c, from where it resumes, as detailed above.

Returning to block 320e, if a tear was not detected, the process moves to block 320i, where it its determined whether the data transfer, e.g., writing of the personalization data into the wearable 135, is complete. If no, the process moves to block 320d, from where it resumes, as detailed above. If yes at block 320i, the process is complete, and it moves to block 322, as detailed above, from where the process resumes.

The processes and subprocesses detailed in FIGS. 3A and 3B, from blocks 302 to 326, including blocks 320a-320i, may be repeated for as long as necessary.

FIG. 4 is a flow diagram detailing computer-implemented processes and sub-processes in accordance with embodiments of the disclosed subject matter. These processes, for example, are performed with respect to the chip 136 (for example, including the processing unit as detailed above) of the wearable 135, and in particular detail the processes and subprocesses performed upon writing personalization data to the chip 136. The aforementioned processes reference FIGS. 1 and 2. The aforementioned processes and sub-processes are, for example, performed automatically and in real time.

Initially, with the RP server 116 having knowledge of the exact state of the wearable 135, and removing or accounting for any previously personalized or partly personalized application on the chip 136. The process moves to block 402, where the Issuer Security Domain (ISD) or Supplementary Security Domain (SSD) is selected. A security domain is defined by GlobalPlatform Specification as the on-card entity providing support for the control, security, and communication requirements of the card administrator. The process moves to block 404, where the instance of the application required is created and set as “Non-Selectable”. At block 406, it is determined whether all required applications have been created.

If no, at block 406, the process returns to block 404, from where it resumes. If yes at block 406, the process moves to block 408.

At block 408, the “Install For Personalization” command is sent, by the user device 130, part of a script of commands sent by the RP Server 116 to the ISD (or SSD), with reference to the application to be personalized. Other commands may also be sent in accordance with the specifications of the ISD (or SSD) to achieve the same functionality.

The process moves to block 410, where, one or more “Store Data” commands are sent to the chip 136 to personalize the application. Other commands may also be used or additionally sent in accordance with the specification of the application being personalized to undertake the same or similar functionality. In the case of the Mastercard Mchip Advance Payment application, the command ‘Store Data’ is the only command required. However, this may not be the case for other applications, as the “Store Data” commands are, for example, atomic, and, for example, when multiple commands are required to be used together to complete a single function, the commands are all atomic.

The “Install for Personalization” command allows an application to be personalized, without directly selecting it. This functionality is, for example, required for personalizing the payment and Payment System Environment (PSE)/PPSE applications, on certain devices, for example iPhones® from Apple®.

The “Install for Install” command, is, for example, used for setting up the device 130 before it is sent to the user 131. In cases where repersonalization is needed, this command may also be undertaken as part of the personalization process from an NFC mobile phone, such as the device 130.

The “Install for Make Selectable” command is, for example, used when finalizing the personalization of the device/wearable once all personalization data has been sent required, for example, from the device 130 to the wearable 135. This command, for example, is one of the commands which is sent from the device 130 to the wearable 135 when the user 131 is completing the personalization process.

The “Install for Install and Make Selectable” command, is a combination of the “Install for Install” and “Install for Make Selectable” commands. This command, for example, is typically atomic, for both of its commands, or if not, when resent, after only the “Install for Install” part has been completed, the command will successfully complete or error in such a way that the Rapid Personalization server (RP) 116 can identify only the “Install for Make Selectable” command, which is still required to be undertaken.

Moving to block 412, the system 116′ determines whether the process fails during the transmission of store data commands to the chip 136 by the user device 130. If there is a failure at block 412, the process moves to block 414, where the point at which the failure occurs is sent to the RP server 116 and a new script of commands is received in accordance with the process of blocks 320f, 320g, and 320h, the processes of these blocks performed, as previously stated above. If there is not a failure at block 412, all store data commands have been successfully processed by the chip 136, and the process then moves to block 416, where it is determined whether all applications have been personalized.

If no, at block 416, the process moves to block 410, from where it resumes, as detailed above. If yes, at block 416, the process moves to block 418. At block 418, the state of the applications are changed from “Non-Selectable” to “Selectable”. The process moves to block 420, where it ends.

The process of blocks 402-420 may be repeated for as long as necessary.

While the present disclosed subject matter has been shown with wearables, this is exemplary only. The present disclosed subject matter is also usable for consumer provisionable articles, such as metal cards. The present disclosed subject matter is also usable with NFC capable devices incorporating smart cards or secure elements, as well as smart cards including those in the form factor of a wearable. Additionally, the disclosed subject matter may be used in applications, including but not limited to, non EMV compliant payment applications, Access control, and Identity applications.

Embodiments of the disclosed subject matter provide a method for personalizing a wearable. The method comprises: providing account data, based on details of a card associated with a token, from a tokenization platform to a personalization server; by the personalization server, processing the account data into writable data, for transmission to a wearable; and, transmitting the writeable data to a device associated with the card and the account data, for personalizing a wearable including writing the writable data to the wearable from the device. Optionally, the method is such that the wearable includes at least one of a ring, wristband, or jewelry, or be in possession of a consumer such as a key fob or exotic cards such as jewelry, biometric, display and metal cards. Optionally, the method is such that the writing data to the wearable is performed by one or more commands for the installation of the writeable data onto a data receiver of the wearable. Optionally, the method is such that the one or more commands include at least one install for personalization command to avoid a block for an application which prevents communication between the device and at least one application of the wearable. Optionally, the method is such that the one or more commands are atomic. Optionally, the method is such that it additionally comprises: tracking the progress of the personalization of the wearable, such that if the personalization is interrupted, the personalization may be resumed from the point of the interruption. Optionally, the method is such that the data receiver includes a programmable chip. Optionally, the method is such that the card includes one or more of a payment card, a credit card, and/or debit card.

### EXAMPLES

### Example 1

A method for personalizing a wearable comprising: obtaining account data, based on details of a card associated with a token, from a tokenization platform to a personalization server (e.g., a rapid personalization server); by the personalization server, processing the account data into writable data, for transmission to the wearable; and, transmitting the writeable data to a device associated with the card and the account data, for personalizing a processing unit coupled to the wearable, the personalizing including writing the writable data to the processing unit from the device.

### Example 2

The method of Example 1, wherein the wearable includes at least one of a ring, wristband, or jewelry, or be in possession of a consumer such as a key fob or exotic cards such as jewelry, biometric, display and metal cards.

### Example 3

The method of Example 1 or Example 2, wherein the writing data to the processing unit is performed by one or more commands for the installation of the writeable data onto the processing unit.

### Example 4

The method of any of Example 1 to Example 3, wherein the one or more commands include at least one install for personalization command to avoid a block for an application which prevents communication between the device and at least one application of the processing unit.

### Example 5

The method of any one of Example 1 to Example 4, wherein the one or more commands are atomic.

### Example 6

The method of any one of Example 1 to Example 5, additionally comprising: tracking the progress of the writing of the writable data to the processing unit, such that if the writing is interrupted, the writing is resumed from at least the point of the interruption.

### Example 7

The method of any one of Example 1 to Example 6, wherein the processing unit includes one or more of a processor and a memory.

### Example 8

The method of any one of Example 1 to Example 7, wherein the processing unit includes one or more of a processor, a memory, a network device and a user interface.

### Example 9

The method of any one of Example 1 to Example 8, wherein the card includes one or more of a payment card, a credit card, and/or debit card.

### Example 10

A system for personalizing a wearable comprising: a first computer for obtaining account data from a token issued by the issuer of the card associated with an account of a user; and, a non-transitory storage medium for storing computer components; and, a computerized processor for executing the computer components. The computerized components comprise: a first module for obtaining account data from a token associated with a card of a user; a second module for processing the obtained account data into writable data for receipt by a processing unit coupled to the wearable associated with the user; and, a third module transmitting the writeable data to a device associated with the card and the account data, the writable data executable by the device, for writing the writable data to the processing unit coupled to the wearable from the device, such when the writing of the writeable data is complete, the wearable is operable in place of the card.

### Example 11

The system of Example 10, wherein the wearable includes at least one of a ring, wristband, or jewelry, or be in possession of a consumer such as a key fob or exotic cards such as jewelry, biometric, display and metal cards.

### Example 12

The system of Example 10 or Example 11, wherein the writing the writable data to the processing unit coupled to the wearable includes one or more commands for the installation of the writeable data onto the processing unit coupled to the wearable.

### Example 13

The system of any one of Example 10 to Example 12, wherein the one or more commands include at least one install for personalization command to avoid a block for an application which prevents communication between the device and at least one application of the processing unit coupled to the wearable.

### Example 14

The system of any of Example 10 to Example 13, wherein the one or more commands are atomic.

### Example 15

The system of any of Example 10 to Example 14, additionally comprising: a fourth module for tracking the progress of the writing of the writable data by the device to the processing unit coupled to the wearable, such that if the writing is interrupted, the writing resumes from at least the point of the interruption.

### Example 16

The system of any of Example 10 to Example 15, wherein the processing unit includes one or more of a processor and a memory.

### Example 17

The system of any of Example 10 to Example 16, wherein the card includes one or more of a payment card, a credit card, and/or debit card.

### Example 18

The system of any of Example 10 to Example 17, additionally comprising: a computer configured for tokenizing account data associated with a card issued by a card issuer.

### Example 19

A computer usable non-transitory storage medium having a computer program embodied thereon for causing a suitably programmed system to personalize a wearable, by performing the following steps when such program is executed by the system. The steps comprise: obtaining account data from a token associated with a card of a user; processing the obtained account data into writable data for receipt by a wearable associated with the user; and, transmitting the writeable data to a device associated with the card and the account data, the writable data executable by the device, for writing the writable data to a processing unit coupled to the wearable, from the device, such when the writing of the writeable data is complete, the wearable is operable in place of the card.

### Example 20

The computer usable non-transitory storage medium of Example, 19, wherein the wearable is selected from the group of at least one of a ring, wristband, or jewelry, or be in possession of a consumer such as a key fob or exotic cards such as jewelry, biometric, display and metal cards.

### Example 21

The computer usable non-transitory storage medium of Example 19 or Example 20, wherein the processing unit includes one or more of a processor and a memory.

### Example 22

The computer usable non-transitory storage medium of any one of Example 19 to Example 21, wherein the steps additionally comprise: tracking the progress of the writing of the writable data by the device to the processing unit coupled to the wearable, such that if the writing is interrupted, the writing resumes from at least the point of the interruption.

### Example 23

A method for personalizing a wearable comprising: obtaining a wearable for personalization, the wearable having been at least partially personalized with a portion of data associated with a card account for personalizing the wearable; obtaining account data, based on details of a card associated with a token, from a tokenization platform to a personalization server; by the personalization server, processing the account data into writable data, for transmission to a processing unit coupled to the wearable; and, transmitting the writeable data to a device associated with the card and the account data, for personalizing a wearable including writing at least a remaining portion of the account data as the writable data, to the processing unit coupled to the wearable from the device, to complete the personalization of the wearable.

### Example 24

The method of Example 23, wherein, prior to transmitting the writeable data to the device, reading the processing unit coupled to the wearable to determine the amount of the writeable data in the portion of the data having at least partially personalized the wearable.

### Example 25

The method of Example 23 or Example 24, wherein the reading the processing unit coupled to the wearable includes reading one or more references associated with the data in the processing unit, from the processing unit.

### Example 26

The method of any one of Example 23 to Example 25, wherein the one or more references are associated with the amount of data and the type of data.

### Example 27

The method of any one of Example 23 to Example 26, wherein the one or more references are associated with the amount of data and the type of data.

### Example 27

The method of any one of Example 23 to Example 26, wherein at least a remaining portion of the account data for providing as the writable data to the processing unit coupled to the wearable from the device, to complete the personalization of the wearable, includes, the amount of account data corresponding to the remaining account data which was not part of the determined amount of the writable data in the portion of the data having at least partially personalized the wearable.

### Example 28

The method of any one of Example 23 to Example 27, wherein the wearable personalized with a portion of data associated with the card account for personalizing the wearable is such that the portion of the data is obtained using a data sharing application on a processing unit coupled to the wearable.

### Example 29

The method of any one of Example 23 to Example 28, wherein the processing unit includes one or more of a processor and a memory.

In the description and claims of the present application, each of the verbs, “comprise,” “include” and “have”, and conjugates thereof, are used to indicate that the object or objects of the verb are not necessarily a complete listing of components, elements or parts of the subject or subjects of the verb. Implementation of the method and/or system of embodiments of the disclosed subject matter can involve performing or completing selected tasks manually, automatically, or a combination thereof. Moreover, according to actual instrumentation and equipment of embodiments of the method and/or system of the disclosed subject matter, several selected tasks could be implemented by hardware, by software or by firmware or by a combination thereof using an operating system.

For example, hardware for performing selected tasks according to embodiments of the disclosed subject matter could be implemented as a chip or a circuit. As software, selected tasks according to embodiments of the disclosed subject matter could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

The above-described processes, including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method for personalizing a wearable comprising:
obtaining account data, based on details of a card associated with a token, from a tokenization platform to a personalization server;
by the personalization server, processing the account data into writable data, for transmission to the wearable; and
transmitting the writeable data to a device associated with the card and the account data, for personalizing a processing unit coupled to the wearable, the personalizing including writing the writable data to the processing unit from the device.

2. The method of claim 1, wherein the wearable includes at least one of a ring, wristband, or jewelry, or be in possession of a consumer such as a key fob or exotic cards such as jewelry, biometric, display and metal cards.

3. The method of claim 1, wherein the writing data to the processing unit is performed by one or more commands for the installation of the writeable data onto the processing unit.

4. The method of claim 3, wherein the one or more commands include at least one install for personalization command to avoid a block for an application which prevents communication between the device and at least one application of the processing unit.

5. The method of claim 4, wherein the one or more commands are atomic.

6. The method of claim 1, additionally comprising: tracking the progress of the writing of the writable data to the processing unit, such that if the writing is interrupted, the writing is resumed from at least the point of the interruption.

7. The method of claim 3, wherein the processing unit includes one or more of a processor and a memory.

8. The method of claim 3, wherein the processing unit includes one or more of a processor, a memory, a network device and a user interface.

9. The method of claim 1, wherein the card includes one or more of a payment card, a credit card, and/or debit card.

10. A system for personalizing a wearable comprising:
a first computer for obtaining account data from a token issued by the issuer of the card associated with an account of a user; and
a non-transitory storage medium for storing computer components; and
a computerized processor for executing the computer components comprising:
a first module for obtaining account data from a token associated with a card of a user;
a second module for processing the obtained account data into writable data for receipt by a processing unit coupled to the wearable associated with the user; and
a third module transmitting the writeable data to a device associated with the card and the account data, the writable data executable by the device, for writing the writable data to the processing unit coupled to the wearable from the device, such when the writing of the writeable data is complete, the wearable is operable in place of the card.

11. The system of claim 10, wherein the wearable includes at least one of a ring, wristband, or jewelry, or be in possession of a consumer such as a key fob or exotic cards such as jewelry, biometric, display and metal cards.

12. The system of any of claim 10, wherein the writing the writable data to the processing unit coupled to the wearable includes one or more commands for the installation of the writeable data onto the processing unit coupled to the wearable.

13. The system of claim 12, wherein the one or more commands include at least one install for personalization command to avoid a block for an application which prevents communication between the device and at least one application of the processing unit coupled to the wearable.

14. The system of claim 13, the one or more commands are atomic.

15. The system of claim 10, additionally comprising: a fourth module for tracking the progress of the writing of the writable data by the device to the processing unit coupled to the wearable, such that if the writing is interrupted, the writing resumes from at least the point of the interruption.

16. The system of claim 10, wherein the processing unit includes one or more of a processor and a memory.

17. The system of claim 10, wherein the card includes one or more of a payment card, a credit card, and/or debit card.

18. The system of claim 10, additionally comprising: a computer configured for tokenizing account data associated with a card issued by a card issuer.

19. A computer usable non-transitory storage medium having a computer program embodied thereon for causing a suitably programmed system to personalize a wearable, by performing the following steps when such program is executed by the system, the steps comprising:
obtaining account data from a token associated with a card of a user;
processing the obtained account data into writable data for receipt by a wearable associated with the user; and
transmitting the writeable data to a device associated with the card and the account data, the writable data executable by the device, for writing the writable data to a processing unit coupled to the wearable, from the device, such when the writing of the writeable data is complete, the wearable is operable in place of the card.

20. The computer usable non-transitory storage medium of claim 19, wherein the wearable is selected from the group of at least one of a ring, wristband, or jewelry, or be in possession of a consumer such as a key fob or exotic cards such as jewelry, biometric, display and metal cards.

21. The system of claim 19, wherein the processing unit includes one or more of a processor and a memory.

22. The computer usable non-transitory storage medium of claim 19, wherein the steps additionally comprise: tracking the progress of the writing of the writable data by the device to the processing unit coupled to the wearable, such that if the writing is interrupted, the writing resumes from at least the point of the interruption.

23. A method for personalizing a wearable comprising:
obtaining a wearable for personalization, the wearable having been at least partially personalized with a portion of data associated with a card account for personalizing the wearable;
obtaining account data, based on details of a card associated with a token, from a tokenization platform to a personalization server;
by the personalization server, processing the account data into writable data, for transmission to a processing unit coupled to the wearable; and,
transmitting the writeable data to a device associated with the card and the account data, for personalizing a wearable including writing at least a remaining portion of the account data as the writable data, to the processing unit coupled to the wearable from the device, to complete the personalization of the wearable.

24. The method of claim 23, wherein, prior to transmitting the writeable data to the device, reading the processing unit coupled to the wearable to determine the amount of the writeable data in the portion of the data having at least partially personalized the wearable.

25. The method of claim 23, wherein the reading the processing unit coupled to the wearable includes reading one or more references associated with the data in the processing unit, from the processing unit.

26. The method of claim 25, wherein the one or more references are associated with the amount of data and the type of data.

27. The method of claim 23, wherein at least a remaining portion of the account data for providing as the writable data to the processing unit coupled to the wearable from the device, to complete the personalization of the wearable, includes, the amount of account data corresponding to the remaining account data which was not part of the determined amount of the writable data in the portion of the data having at least partially personalized the wearable.

28. The method of claim 23, wherein the wearable personalized with a portion of data associated with the card account for personalizing the wearable is such that the portion of the data is obtained using a data sharing application on a processing unit coupled to the wearable.

29. The method of claim 23, wherein the processing unit includes one or more of a processor and a memory.
